(19) United States
(12) Patent Application Publication
(10) Pub. No.: US 2013/0095215 A1
(43) Pub. Date: Apr. 18, 2013

(54) FOOD PACKAGE FOR CUT PRODUCE

(71) Applicant: PAPER-PAK INDUSTRIES, Laverne, CA (US)

(72) Inventors: Ronald JENSEN, Chicago, IL (US); Sayandro VERSTEYLEN, Ontario, CA (US)

(73) Assignee: PAPER-PAK INDUSTRIES, Laverne, CA (US)

(21) Appl. No.: 13/651,983

(22) Filed: Oct. 15, 2012

Related U.S. Application Data
(60) Provisional application No. 61/547,705, filed on Oct. 15, 2011.

(51) Int. Cl. B65D 81/28; A23B 7/148

(52) U.S. Cl. 426/124

(57) ABSTRACT

The present disclosure provides a food package system for cut or sliced produce. The food package system includes a food tray, tray insert, closure, and an absorbent food pad positioned directly below the tray insert that absorbs exuded liquid from the cut or sliced produce, and contains active agents that modify the atmosphere in the food package system and have antimicrobial activity. The absorbent food pad absorbs liquids from the cut or sliced produce and keeps the absorbed liquids separated from the produce to extend shelf life, preserve appearance and other organoleptic features, and reduce spoilage of the cut or sliced produce in the food package system.

### CROSS-REFERENCE TO RELATED APPLICATIONS

This application claims the benefit of U.S. Provisional Application No. 61/547,705, filed Oct. 15, 2011.

### BACKGROUND OF THE DISCLOSURE

### Field of Disclosure

The present disclosure relates to an active, absorbent food pad for cut or sliced produce in a food package system, to extend shelf life, preserve appearance, and reduce spoilage of the cut or sliced produce in the food package system.

### SUMMARY OF THE DISCLOSURE

The present disclosure provides an active, absorbent food pad for cut or sliced produce in a food package system that manages liquid exuded from the cut produce in order to achieve at least one or more of the following: extend shelf life, preserve appearance and other organoleptic features, and reduce spoilage of the cut or sliced produce in the food package system.

For packaging cut or sliced produce, the active, absorbent food pad can be placed inside a food tray on its bottom surface and beneath an impermeable tray insert that fits within the inner length and inner width of the food tray. The cut or sliced produce is positioned on the tray insert, which can have channels or grooves to direct any liquid exuded from the cut produce from the center of the tray insert outward to its periphery (outer edge).

The tray insert has a small space between the outer edge of the tray insert and the food tray that provides a path for exuded liquid to drop over the outer edge of the tray insert to the portion of the food tray that is below the tray insert. The food tray, which usually has a bottom and sides walls, can have grooves and channels of its own to provide another pathway for exuded liquids from cut produce to drip down its side walls into the area of the food tray below the tray insert, where the liquid can be absorbed by the active, absorbent food pad. Each of the outer edges of the tray insert can be beveled or chamfered to create a downward slope that further directs exuded liquids onto that portion of the food tray located below the tray insert. The cut or sliced produce in the food package system is thereby kept separated and isolated from the liquids that it exuded, which extends the shelf life, improves the appearance and other organoleptic features, and reduces spoilage of cut or sliced produce.

Cut or sliced produce include vegetables that include, but are not limited to, tomato, onion, asparagus, celery, and lettuce, as well as fruits that include, but are not limited to, melon, berry, pineapple, apple, grape, and combinations of vegetables or fruits, such as a vegetable medley, salad, or fruit medley.

Cut or sliced produce, which also includes chopped and/or pierced produce, usually exudes water and other liquids more rapidly, and in greater volume, than comparable “whole” (uncut) produce. For this reason, cut or sliced produce tends to deteriorate more quickly than whole produce. Thus, for fresh-cut or sliced produce, liquid management is critical to preserving freshness, extending shelf life, improving appearance, and reducing spoilage. Liquid management can be achieved by placing an active, absorbent food pad below the tray insert and on the bottom surface on the inside of the food tray, where the food pad absorbs liquid exudates from the cut or sliced produce.

The absorbent food pad has an “architecture” that is an ordered configuration of layers of absorbent materials and of active agents that provides effective liquid management for the particular type of cut or sliced produce in the food package system. The active agents in the absorbent food pad can modify the atmosphere in the food package and/or have antimicrobial activity that further extend shelf life, improve the appearance, smell, and other organoleptic features, and reduce spoilage of the cut or sliced produce. The pad architecture, as well as the type and amount of active agents placed in the pad architecture, can be specifically selected based on the type of cut or sliced produce in the food package system.

### BRIEF DESCRIPTION OF THE DRAWINGS

FIG. 1 is a top view of an exemplary embodiment of an active, absorbent food pad positioned on the bottom of a food tray as part of a food package system of the present disclosure.

FIG. 2 is a top view of an exemplary embodiment of a food package system of the present disclosure including a food tray, a tray insert, and an absorbent food pad for cut or sliced produce that is positioned on the bottom of the food tray and directly below the tray insert.

FIG. 3 is a side, perspective view of an exemplary embodiment of the food package system of the present disclosure packaging sliced tomatoes.

FIG. 4 is a side, perspective view of an exemplary embodiment of the food package system of the present disclosure for packaging sliced onions.

FIG. 5 is an illustration of an exploded view of the “architecture” of an exemplary embodiment of an active, absorbent food pad for cut or sliced produce.

FIG. 6 through FIG. 9 is a series of illustrations showing the operation of the food package in FIG. 3.

FIG. 6 illustrates an exemplary embodiment of a food package system of the present disclosure with sliced tomatoes therein, in which liquid exuded from the sliced tomatoes is absorbed by the absorbent food pad.

FIG. 7 also illustrates the food package system in FIG. 6 and shows the event in which the absorbed liquids interact with the active agents in the absorbent food pad to activate and release the active agents.

FIG. 8 further illustrates the food package system in FIG. 6 and shows the event in which the active agents are dissolved by the absorbed liquids and combine to generate carbon dioxide (CO₂) in the food package system, modifying the atmosphere therein.

FIG. 9 still further illustrates the food package system in FIG. 6 and shows the event in which CO₂ that is generated by the active agents in the food package system diffuses through the lidding film and out of the food package system, thereby keeping a positive partial pressure and favorable flow of CO₂ in the food package system.

FIG. 10A and FIG. 10B show results of testing of an exemplary embodiment of a food package of the present disclosure (FIG. 10A) and a control (FIG. 10B) after adding 50 mL of water.

FIG. 11 is a magnified view of the control pad in FIG. 10B after adding 50 mL of water.

FIG. 12A and FIG. 12B show results of testing of an exemplary embodiment of a food package of the present disclosure (FIG. 12A) and a control (FIG. 12B) after adding 100 mL of water.

FIG. 13 is a magnified view of the control pad in FIG. 12B after adding 100 mL of water.

FIG. 14A and FIG. 14B show results of testing of an exemplary embodiment of a food package of the present disclosure (FIG. 14A) and a control (FIG. 14B) after adding 300 mL of water.

FIG. 15A shows the results of testing of an exemplary embodiment of a food package of the present disclosure revealing small amounts of unabsorbed liquids on the food tray, after removal of the absorbent food pad and channeled tray insert. FIG. 15B shows the results of testing of a “control” food package, revealing unabsorbed liquids on the food tray, after removal of the absorbent food pad.

FIG. 16 is a graph showing the antimicrobial effectiveness of the food package of the present disclosure enclosing sliced tomatoes by measuring the aerobic plate counts (log cfu/g) over a 9-day test period between the “S−9” date (9 days prior to the sell-by date) and the Sell-By date “S” comparing an absorbent food pad having active agents with a regular absorbent food pad (control).

FIG. 17 is a graph showing the antimicrobial effectiveness of the food package of the present disclosure enclosing sliced tomatoes by measuring yeast and mold total plate counts (log cfu/g) over a 9-day test period between the “S−9” date (9 days before the sell-by date) and the Sell-By date “S” comparing an absorbent food pad having active agents with a regular absorbent food pad (control).

FIG. 18 is a bar graph showing color values for a “fruit medley” (variety of cut fruits) by hedonic values on a scale from 0 (worst) to 9 (best) over a 10-day test period between the “S−7” date (7 days before the sell-by date) and the “S+2” (2 days after the sell-by date) by comparing scores for the hedonic values of a fruit medley in a food package having an absorbent food pad with active agents against the results using a regular absorbent food pad (control).

FIG. 19A through FIG. 19D are pictures showing the appearance of sliced tomatoes from a shelf-life study, where FIG. 19 A and FIG. 19B are sliced tomatoes at Day 10 and Day 12, respectively, for an absorbent food pad having active agents that are a CO₂ generation system and an antimicrobial (XtendaPak™) as compared against FIG. 19C and FIG. 19D, which show sliced tomatoes at Day 10 and Day 12, respectively, for a Control absorbent food pad.

FIG. 20A and FIG. 20B show the results of a shelf-life study for cut celery in a food pouch at Day 14, where FIG. 20A is the cut celery when an XtendaPak™ absorbent food pad is used in the pouch, as compared with FIG. 20B for cut celery stored with a Control absorbent food pad in the pouch.

### DETAILED DESCRIPTION OF THE DISCLOSURE

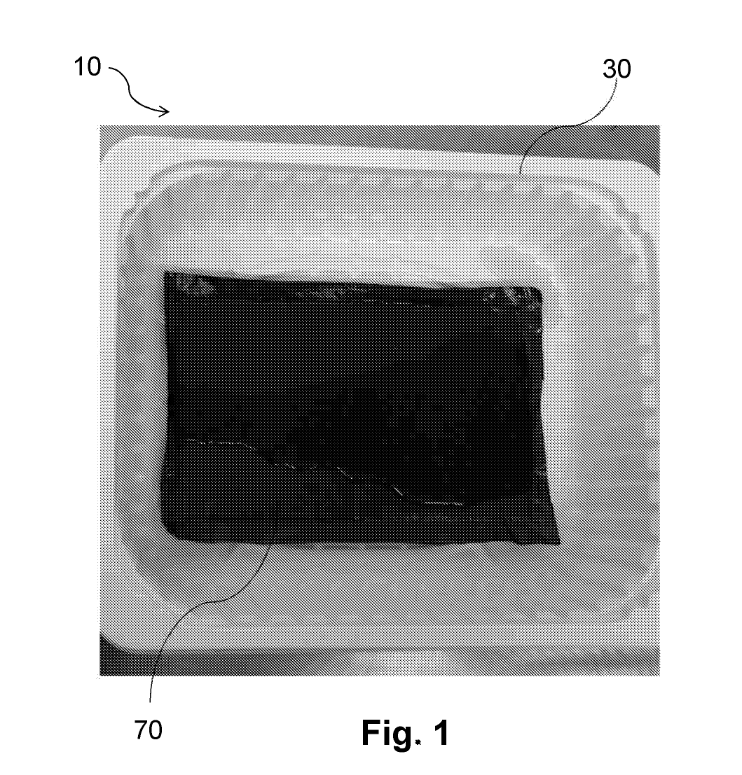

Referring to the drawings, and in particular, FIGS. 1 to 4, there is provided an exemplary embodiment of an active, absorbent food pad 70 for cut or sliced produce that can be used in a food package system of the present disclosure generally represented by reference number 10. Food package system 10 includes an outer food tray 30, a tray insert 50, and an absorbent food pad 70 that is positioned on the bottom of food tray 30 and directly below tray insert 50. In FIG. 1, food package system 10 is shown with absorbent food pad 70 positioned on the bottom of food tray 30, but without tray insert 50 (which would normally be positioned directly over absorbent food pad 70), so the position of absorbent food pad 70 can be seen clearly.

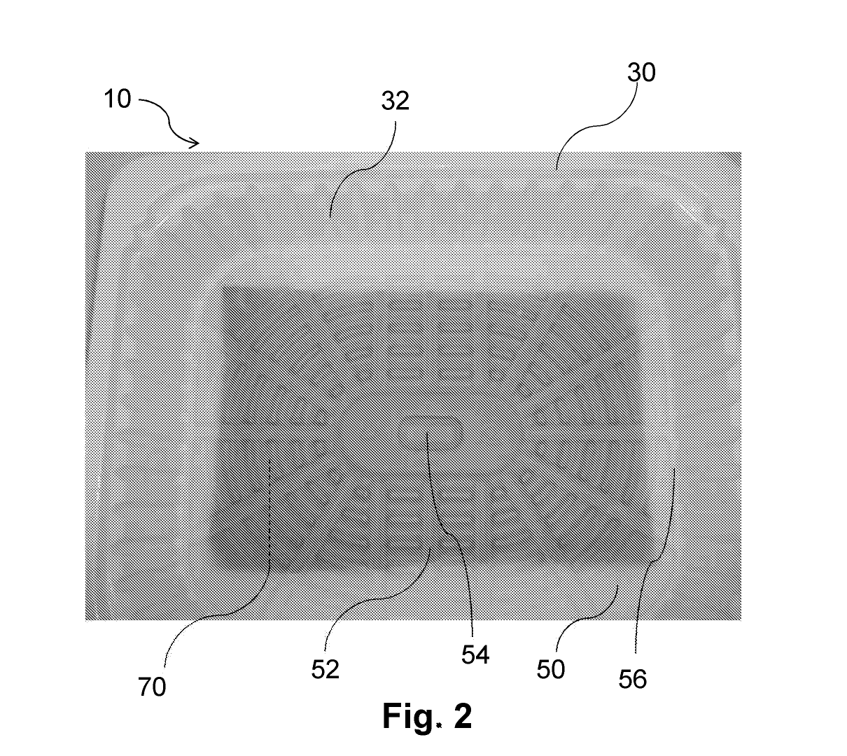

FIG. 2 shows an exemplary embodiment of food package system 10 including absorbent food pad 70 positioned on the bottom of food tray 30, and tray insert 50 positioned directly over the absorbent food pad. The liquid exuded by the cut or sliced produce that is positioned on tray insert 50 is directed toward an outer perimeter 56 (also called an “outer edge” of the tray insert) that extends around the periphery of tray insert 50, where the exuded liquid drops over outer perimeter 56 to the space directly below tray insert 50, where the liquid is absorbed by absorbent food pad 70.

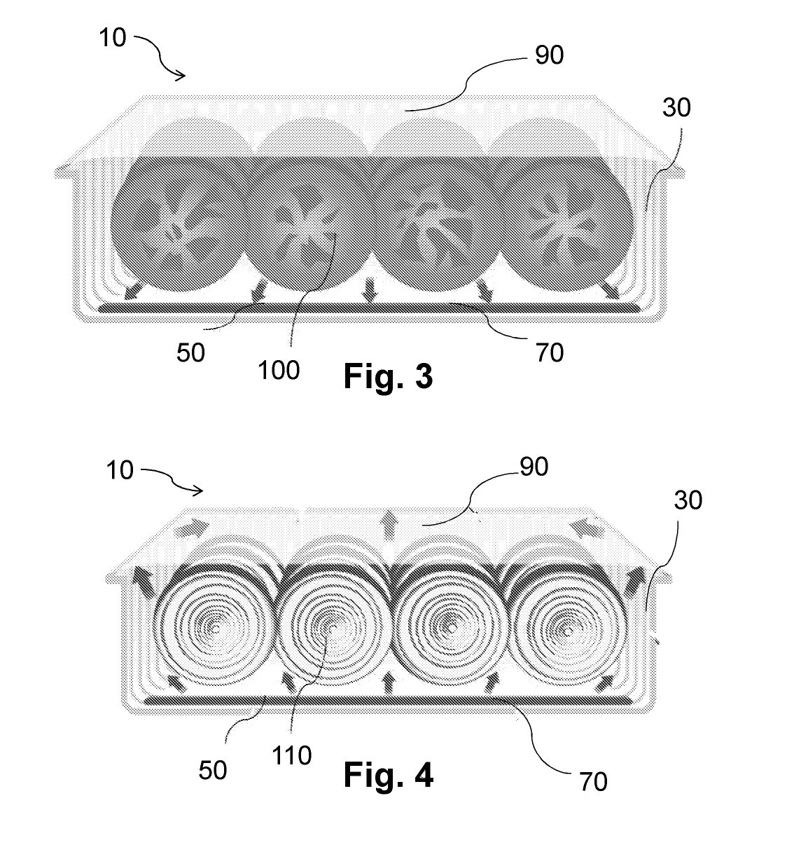

Food tray 30 has a bottom and side walls connected to the bottom to form a top opening. Tray insert 50 has an outer perimeter 56 sized so that tray insert 50 can be positioned inside the food tray. After the cut or sliced produce is placed in food package system 10, a closure 90 (as shown in FIGS. 3 and 4) is used to cover the top opening, and thereby enclose and seal the cut or sliced produce in the food package system.

To direct exuded fluids away from the cut or sliced produce and towards outer perimeter 56, tray insert 50 is configured to direct exuded liquids outward from its center portion 54 (where the produce is placed) to its outer perimeter 56. One or more channels 52 can provide a path from center portion 54 to outer perimeter 56. To further increase and direct the flow of exuded liquid towards absorbent pad 70, outer perimeter 56 may be shaped to form a structure or slope, including having beveled or chamfered edges, so that liquid flows over outer perimeter 56 into the space between tray insert 50 and food tray 30, where absorbent food pad 70 is positioned. As in the exemplary embodiment shown in FIG. 2, the top surface of tray insert 50 can be substantially or completely impermeable to liquids exuded from cut or sliced produce, so that exuded liquids flow more rapidly and completely toward outer perimeter 56. A space between outer perimeter 56 and food tray 30 provides a path for exuded liquids to drain over outer perimeter 56 onto a portion of the food tray directly below tray insert 50, where the liquids are absorbed by absorbent food pad 70. Food tray 30 can also have grooves 32 in its side walls that further direct exuded liquids to the space directly below tray insert 50, where the liquids are absorbed by absorbent food pad 70.

FIG. 3 shows an absorbent food pad 70 for cut or sliced produce in food package system 10 on the bottom of food tray 30 and directly below tray insert 50. Sliced tomatoes 100 are positioned on tray insert 50. The sliced tomatoes exude liquids that are directed toward the outer perimeter of the tray insert and to the absorbent food pad, as indicated by the arrows, so that the slices of tomatoes do not remain in contact with their own liquid exudates. A lidding film 90 completely encloses and seals sliced tomatoes 100 in food package system 10.

FIG. 4 shows a similar arrangement of a food package system where the produce is sliced onions. Absorbent food pad 70 is on the bottom surface of food tray 30 and directly below tray insert 50. Sliced onions 110 are positioned on tray insert 50. In this illustration, the liquid exuded by the sliced onions contacts active agents (not shown in FIG. 4) present in absorbent food pad 70, to generate an atmosphere modifying gas (such as CO₂) that circulates inside the food package system as indicated by the arrows in FIG. 4. Again, a lidding film 90 completely encloses and seals sliced onions 110 in food package system 10.

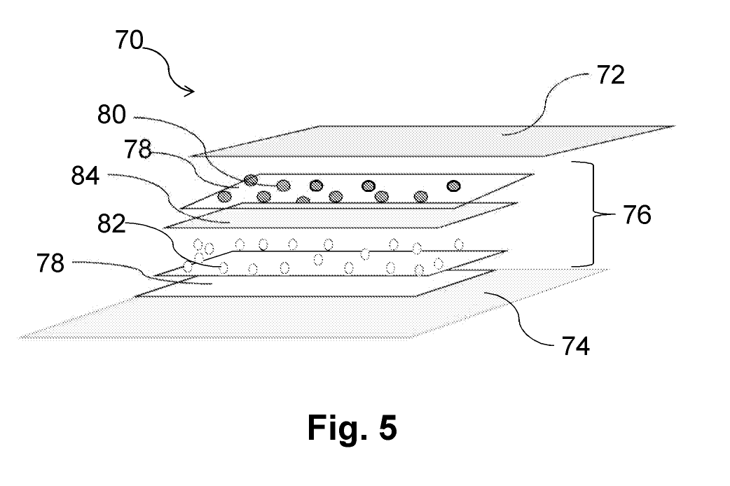

Referring to FIG. 5, an exemplary embodiment of absorbent food pad 70 has a top layer 72 and a bottom layer 74 separated by one or more layers of an absorbent material 76. Absorbent food pad 70 is sealed around its periphery by top layer 72 and bottom layer 74 directly contacting each other along their entire peripheries to enclose the absorbent material.

In a preferred embodiment, top layer 72 of absorbent food pad 70 is a film that is polyethylene, polypropylene, polyester, or any combinations thereof. In an exemplary embodiment, top layer 72 is a blown polyethylene film. The blown polyethylene film can have a thickness of about 0.65 mil.

In a preferred embodiment, bottom layer 74 is a nonwoven material, which can be a hydrophilic nonwoven, or treated with a surfactant or other hydrophilic material to permit liquid uptake into absorbent material 76.

Absorbent material 76 can be one or more tissue layers 78 that absorb liquids exuded from the cut produce in the food package. Each tissue layer 78 is made of a sheet of cellulose tissue, and can itself be formed of one or more individual tissues that are joined together to form the tissue layer. Absorbency can be further enhanced by a superabsorbent material 80 in the absorbent layer. Examples of a superabsorbent material can include, but are not limited to, polyacrylates or carboxymethyl starch (CMS), superabsorbent polymer (SAP), compressed SAP, composite of SAP granules adhered with binder or plasticizer, airlaid with SAP, and/or a starch-based superabsorbent material, such as BioSAP™ (Archer-Daniels Midland, Decatur, Ill.), which is biodegradable and compostable.

Absorbent food pad 70 can have one or more absorbent laminate layer 84 that has one or more plies of a cellulosic material and an active agent. In an exemplary embodiment, laminate layer 84 is made of a mixture of cellulosic material and a CO₂-generation system (active agent 82) that is a mixture of citric acid and sodium bicarbonate, which, when activated by water or other liquid from the cut produce, react with each other to generate CO₂ that is released into the food package environment. Laminate layer 84 can be positioned directly adjacent top layer 72 or bottom layer 74, but is more typically positioned between tissue layers. An absorbent laminate layer is able to incorporate large amounts of an active agent in a relatively thin structure, and can reduce or eliminate the need to add dry, loose compounds that can gather disproportionately in one section of the pad when picked up by edge or cause the absorbent food pad to “bulge.” Also, since the amount of active agents can be uniformly distributed in a laminate layer, selecting a laminate layer having a prescribed amount and number of plies permits the amount of active agent in the absorbent food pad to be readily determined.

Absorbent food pad 70 can have one or more active agents 82. Examples of active agents 82 include, but are not limited to, components of a CO₂-generation system, an oxygen scavenging system, an ethylene inhibitor (e.g., ethylene scavenger, ethylene antagonist), a fungal inhibitor (e.g., botrytis inhibitor), an antimicrobial, or any combinations thereof. An exemplary embodiment of components of a CO₂-generation system are an acid and a base, such as citric acid and sodium bicarbonate, respectively, that react with each other (when activated by water or other liquid) to generate CO₂ gas. The acid component of the CO₂-generation system may be a food-safe organic acid or an inorganic acid, such as boric acid. The ratio and amounts of the acid and base, as well as their physical placement in the pad architecture, can be varied to control the timing and amount of CO₂ released in the food package.

As used in this application, the “architecture” of an absorbent food pad means the structure and order of individual layers of absorbent material and active agents therein.

The architecture of absorbent food pad 70 affects the performance of the packaging for liquid management and preserving freshness of the cut produce. The number and position of tissue layers 78, as well as their arrangement in the overall configuration of absorbent food pad 70, can be varied to regulate the absorption of liquids, as well as activation of any active agents therein. “Regulation” means controlling the speed, location, and amount of liquid absorption, as well as controlling activation speed and duration of release of active agents. Thus, varying pad architecture can be used to regulate activation, rate of release, and duration of the active agent. For instance, a pad architecture that physically separates individual chemical components of an active agent with tissue layers can be selected to delay activation and provide an “extended release” of the active agent contained in absorbent food pad 70.

In a preferred embodiment, absorbent food pad 70 has a pad architecture that is, from top to bottom (a) to (f):

(a) top layer that is a polyethylene film;

(b) four tissue layers;

(c) a laminate layer;

(d) a laminate layer that contains citric acid and sodium bicarbonate;

(e) four tissue layers; and

(f) a bottom layer that is a nonwoven.

In an alternative preferred embodiment, layers (c) and (d) above are reversed to form a pad architecture that is, from top to bottom, (a), (b), (d), (c), (e) and (f). In addition, citric acid powder and sodium bicarbonate powder can be added between the laminate and the fourth tissue layer and/or between the laminate and the fifth tissue layer, as the components of a CO₂ generation system and also (for the citric acid) as an antimicrobial.

In another preferred embodiment, absorbent food pad 70 has a pad architecture that is, from top to bottom:

(a) a top layer that is a polyethylene film;

(b) two tissue layers;

(c) a laminate layer;

(d) citric acid powder and sodium bicarbonate;

(e) a laminate layer;

(f) citric acid powder and sodium bicarbonate;

(g) three tissue layers; and

(h) a bottom layer that is a nonwoven.

One or both of the laminate layers in this embodiment can have a superabsorbent material to enhance absorbency. The superabsorbent can be a starch-based superabsorbent material that is biodegradable and/or compostable, such as BioSAP™ (Archer-Daniels Midland, Decatur, Ill.).

Other absorbent food pads that can be used in the food packages of the present disclosure are described in U.S. patent application publication US 2011/0165294 “Absorbent Pads for Food Packaging,” and in U.S. Pat. No. 7,799,361 “Food Preservation Systems.”

Pre-wetting absorbent food pad 70 (before enclosing the cut of sliced produce in the food package system) can increase the activation speed of active agents 82 therein, but this is not required for the food package system to operate as intended.

Examples of cut of sliced produce that can be packaged in the food packages disclosed herein include, but are not limited to, tomato, onion, asparagus, celery, and lettuce, as well as fruits that include, but are not limited to, melon, berry, pineapple, apple, grape and combinations of vegetables or fruits, such as a vegetable medley, fruit medley, or salad.

When fresh produce is cut for packaging and shipping, the cut produce loses water and deteriorates much faster than does “whole” (i.e., uncut) produce. Food package system 10 extends shelf life and preserves freshness of cut or sliced produce. Consumers equate cut or sliced produce having good organoleptic properties, such as color, smell, texture, and taste, with freshness. Another desirable feature of food package system 10 is that the cut produce is not sitting in a pool of liquid, which is undesirable to consumers. In spite of the lag time from harvest of fresh produce, consumers demand produce that appears fresh.

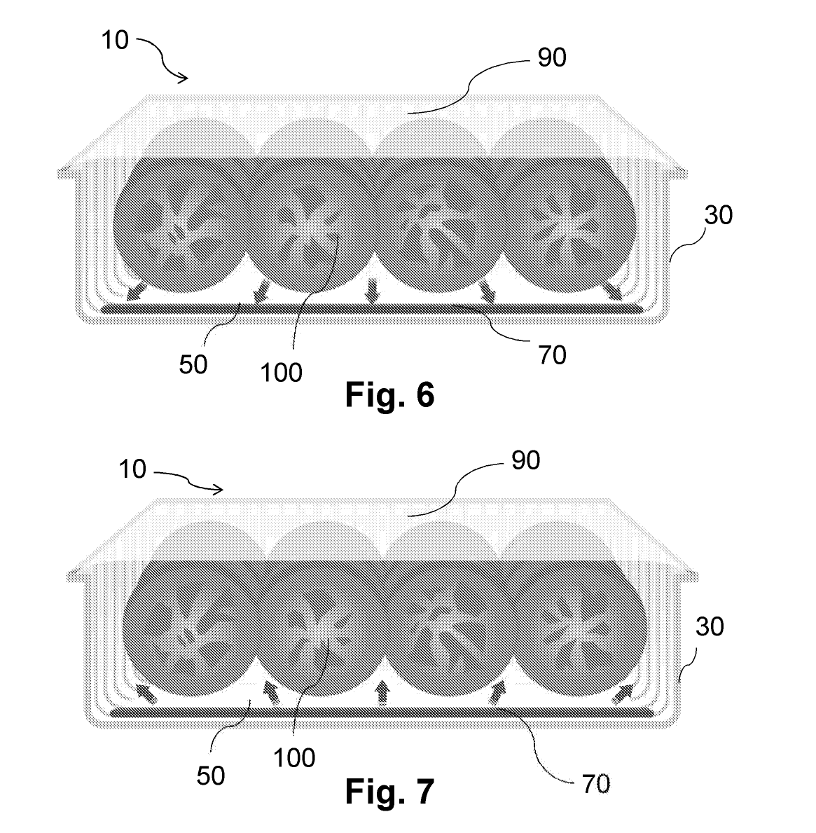

FIGS. 6 through 9 illustrate the operation of an exemplary embodiment of a food package system of the present disclosure, where sliced tomatoes 100 are enclosed by a lidding film 90 in food package system 10. In each of these Figures, food package system 10 has outer food tray 30, tray insert 50, and absorbent food pad 70.

FIG. 6 illustrates the first step, in which liquid exuded from the sliced tomatoes enclosed inside the food package is absorbed by the absorbent food pad.

FIG. 7 illustrates the next step, in which the liquid absorbed by the absorbent food pad interact with active agents to activate the active agents.

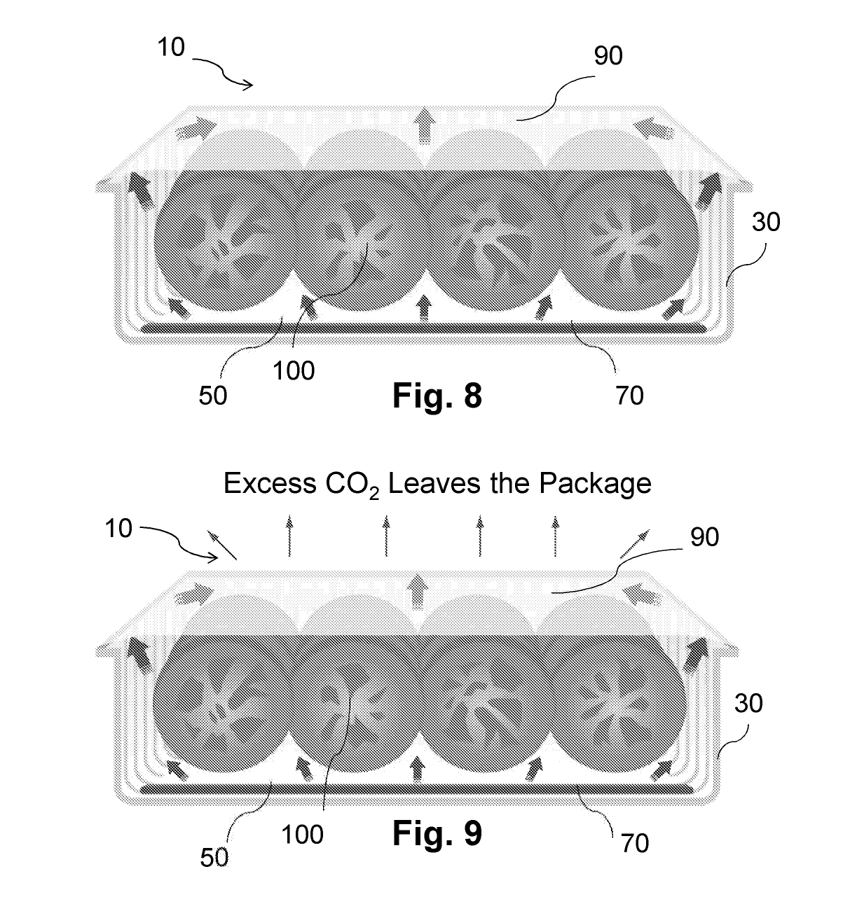

FIG. 8 illustrates the next step, in which the active agents combine to release carbon dioxide (CO₂) in the food package, thereby modifying the atmosphere that envelops the cut produce in the food package.

FIG. 9 illustrates the next step, in which excess CO₂ in the food package is released through the lidding film and out of the food package, keeping a positive partial pressure and flow of CO₂ around the cut produce in the food package.

### Experimental Data

Absorbency/Acquisition Test of Absorbent Food Pads: Test Pad vs. Control Pad

The following test was conducted to determine the absorbency and liquid remaining in the outer tray using an absorbent food pad (XUZFNWN-302) with a channeled tray insert (test) vs. an absorbent food pad XUZFNWN-300C with no channeled tray insert (control).

Conditions:

1838: XUZFNWM-302—4.2 g B60

1839: XUZFNWN-300C—3.9 g B60 (Control)

Protocol:

a. Pull an XUZFNWN-300C absorbent food pad from past production.

b. Hand-make an XUZFNWN-302 absorbent food pad.

c. Activate each pad stepwise with the specified amount of water.
i. First, add 50 mL tap water to top of tray insert, and let stand for 30 minutes.
ii. Lift insert and quickly remove absorbent food pad; weigh pad and measure liquid remaining in tray and insert. Replace pad and tray insert; add left over water.
iii. Add 100 mL of tap water and let stand for 1 hour.
iv. Repeat step ii.
v. Add 100 mL of tap water and let stand for 1 hour.
vi. Repeat step ii.
vii. Add 50 mL of tap water and let stand for 30 minutes.

Test Specifications:

a. Tray: steamer barrier tray

b. Pad absorbency
i. XUZFNWN-300C—300 g
ii. XUZFNWN-302—300 g (control)

The results of the study are summarized in Table 1 below.

Table 1: Results

TABLE 1
Results
Moisture Activation of Absorbent food pads

| | 1838: XUZFNWN-302 22 g (using tray insert) | | | 1839: XUZFNWN-300C 21 g (control) | | |
|---|---|---|---|---|---|---|
| Activation | Pad weight | Absorbency | Tray Retention | Pad weight | Absorbency | Tray Retention |
| Amount (mL) | (g) | (g) | (mL) | (g) | (g) | (mL) |
| 50 mL | 53.0 | 31 | 16.0 | 29.0 | 8 | 39.5 |
| 0.167 | | | | | | |
| 100 mL | 152.0 | 130 | 13.5 | 154.0 | 133 | 11.0 |
| 0.5 | | | | | | |
| 100 mL | 239.0 | 217 | 22.0 | 246.0 | 225 | 15.0 |
| 0.833 | | | | | | |
| 50 mL | 275.0 | 253 | 33.0 | 271.0 | 250 | 37.5 |
| 1 | | | | | | |

Discussion of Study Results:
a. Both pads managed to absorb the vast majority of the water that is added to the tray with no movement, shaking or tilting.
b. The insert retained some water during the course of the experiment, around 5 mL. However, most of the water drains into the bottom tray, even while stationary.
c. The bottom tray holds most of the water not absorbed by the absorbent food pad. If 20 mL of liquid was not absorbed, 190 mL was in the tray and 5 mL was in the insert.
d. It does not appear to matter how much water is added. 18-20 mL remains in the tray bottom, until 100% of the nominal absorbency is added, when a little more water is not absorbed.

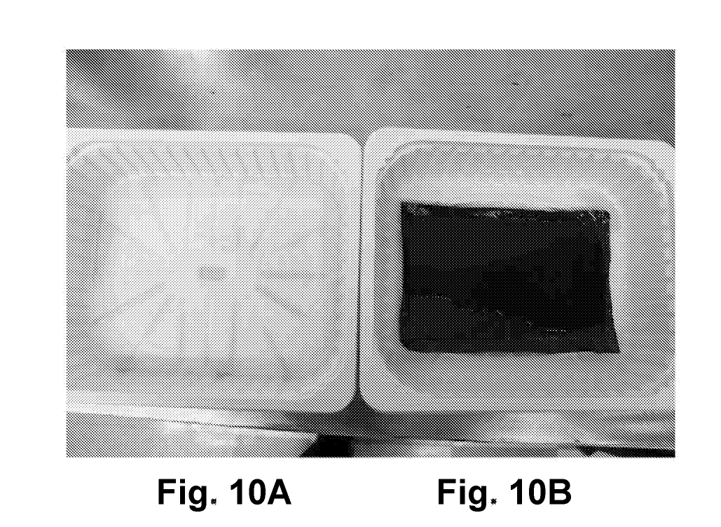

Pictures from studies are shown in FIGS. 10 through 15, as described below.

FIG. 10A and FIG. 10B show a top view of the food package of the test and control conditions after adding 50 mL of water, respectively. Specifically, FIG. 10A shows a food package of the present disclosure (condition 1838, using a food tray and channeled tray insert). FIG. 10B shows the control (condition 1839, using a food tray without an insert).

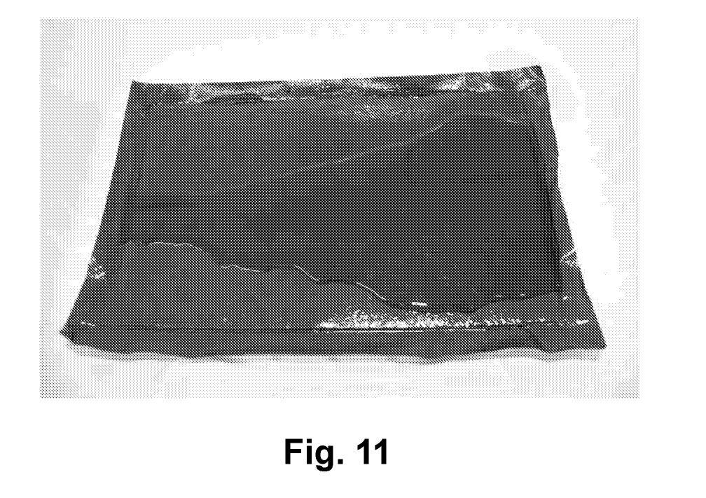

FIG. 11 is a magnified view of the control pad in FIG. 10B (after 50 mL of water was added).

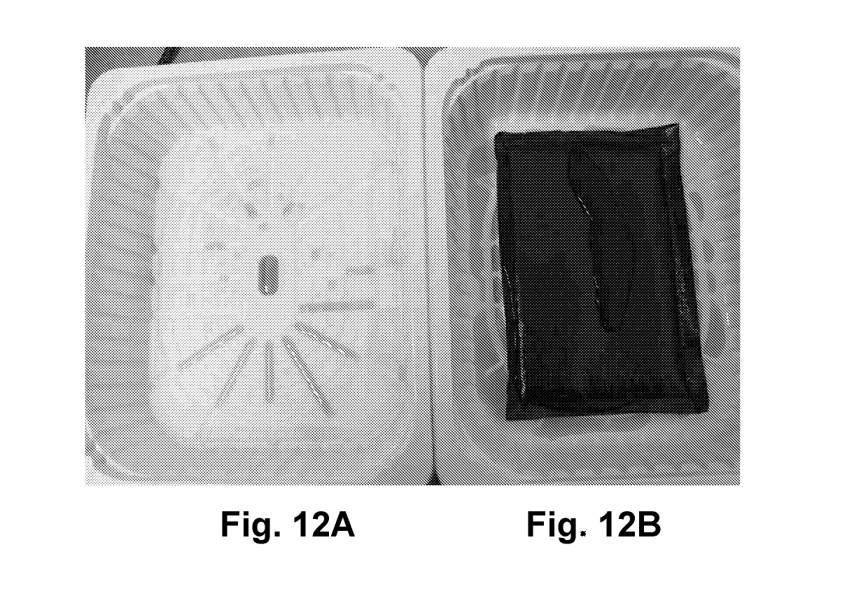

FIG. 12A and FIG. 12B show a top view of the food package of the test and control conditions after adding 100 mL of water, respectively. Specifically, FIG. 12A shows a food package of the present disclosure (condition 1838, using a food tray and channeled tray insert). FIG. 12B shows the control (condition 1839, using a food tray without an insert).

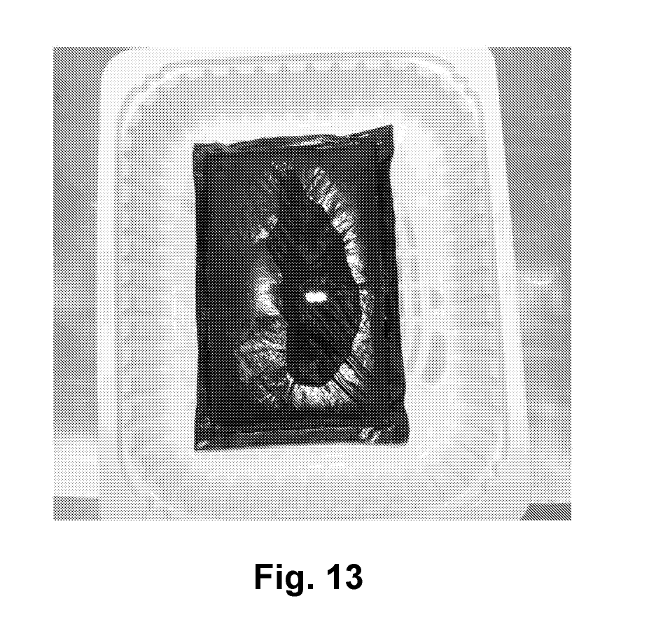

FIG. 13 is a magnified view of the control pad in FIG. 12B after adding 100 mL of water.

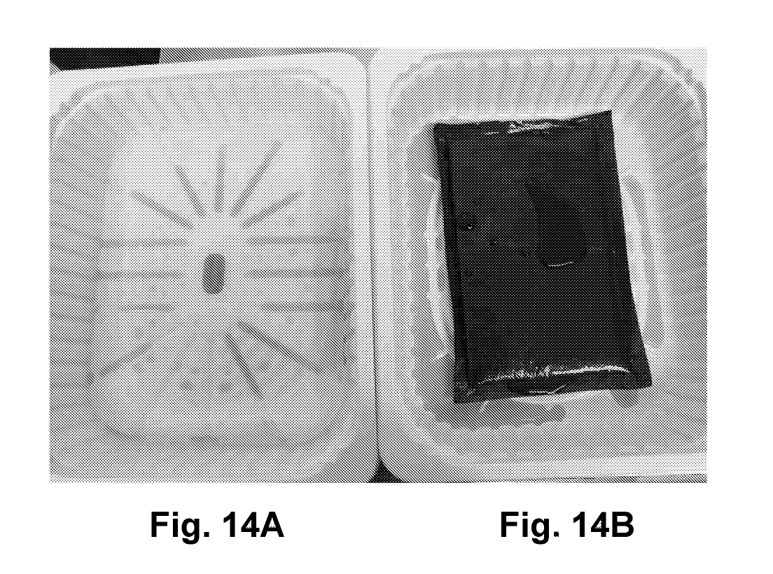

FIG. 14A and FIG. 14B show a top view of the food package of the test and control conditions after adding 300 mL of water, respectively. Specifically, FIG. 14A shows a food package of the present disclosure (condition 1838, using a food tray and channeled tray insert). FIG. 14B shows the control (condition 1839, using a food tray without an insert).

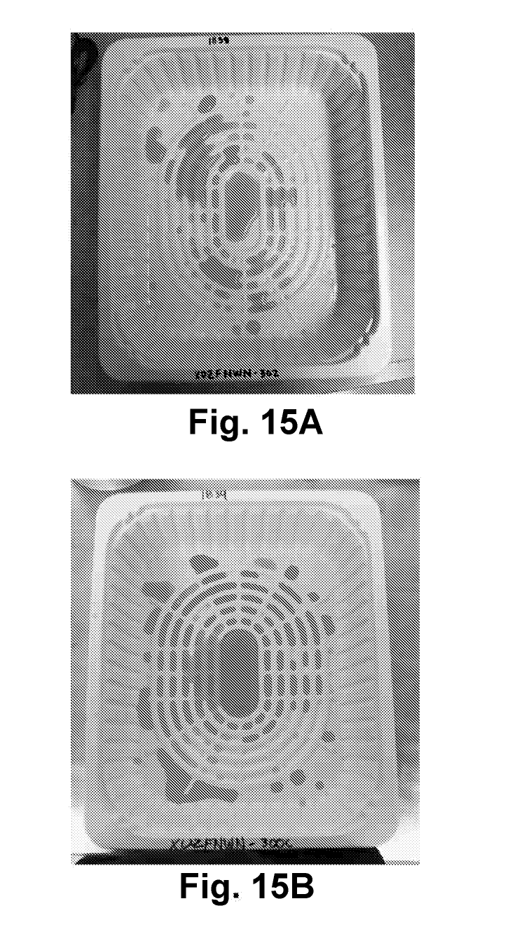

FIG. 15A shows the liquid remaining in the bottom food tray at the end of the test for the food package of the present disclosure (i.e., condition 1838, with a channeled tray insert), after removal of the absorbent food pad and channeled tray insert. FIG. 15B shows the liquid remaining in the bottom food tray at the end of the test for the Control food package (i.e., condition 1839, food tray without a channeled tray insert), after removal of the absorbent food pad.

Conclusions of Study:
a. The channeled tray insert is effective at funneling the liquid away from the tomatoes and into the bottom of the food tray, where the liquid is absorbed by the absorbent food pad.
b. The absorbent food pad absorbs most of the liquid and the vast majority of any remaining liquid remains in the bottom of the food tray, rather than on channeled tray insert, and so the liquid is kept away from the tomatoes.

### Additional Experimental Data

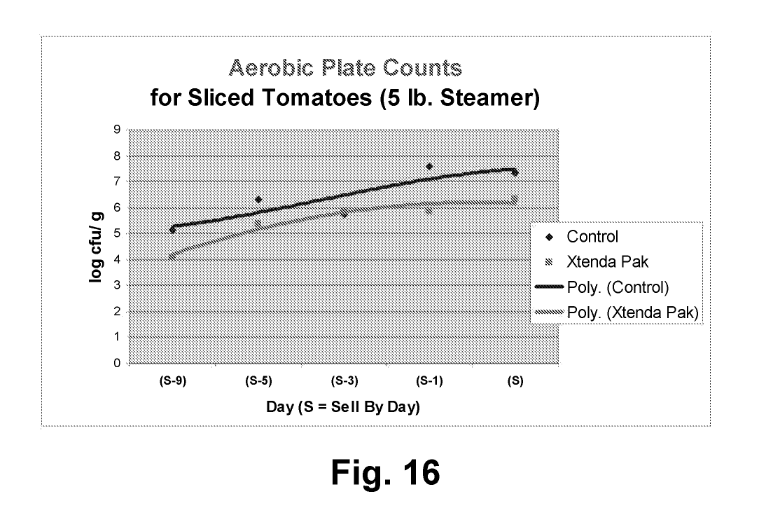

Additional experimental data and results are shown in FIG. 16 through FIG. 20, described below.

FIG. 16 is a graph showing the antimicrobial effectiveness of the food package of the present disclosure enclosing sliced tomatoes by measuring the aerobic plate counts (log cfu/g) over a 9-day test period between the “S−9” date (i.e., 9 days prior to the sell-by date) and the Sell-By date “S” comparing an absorbent food pad having active agents that are a CO₂ generation system and an antimicrobial (XtendaPak™) with a Control absorbent food pad. This data shows that aerobic bacteria counts (cfu/g) were at least one log lower for sliced tomatoes packaged with an XtendaPak™ absorbent food pad as compared with sliced tomatoes packaged with a regular absorbent food pad (Control).

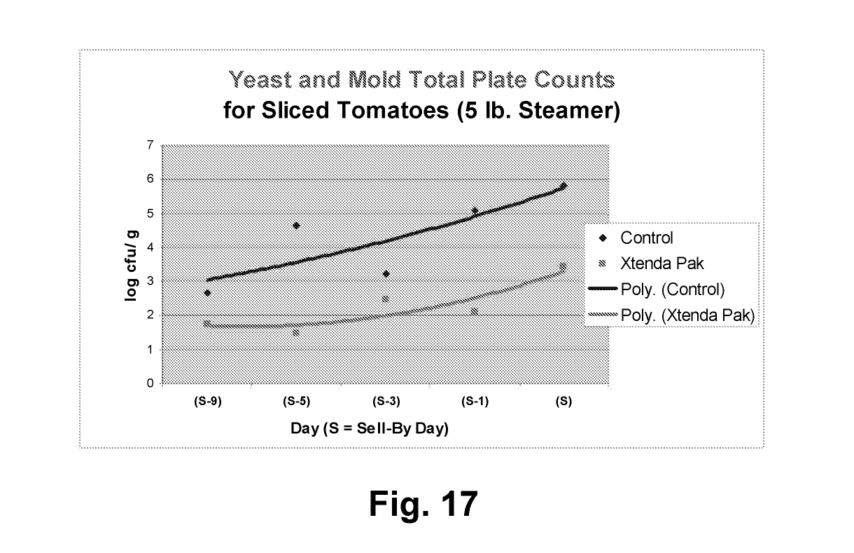

FIG. 17 is a graph showing the antimicrobial effectiveness of the food package of the present disclosure enclosing sliced tomatoes by measuring yeast and mold total plate counts (log cfu/g) over a 9-day test period between the “S−9” date (9 days before the sell-by) and the Sell-By date “S” comparing an absorbent food pad having active agents that are a CO₂ generation system and an antimicrobial (XtendaPak™) with a Control absorbent food pad. This data shows that yeast and mold total plate counts (cfu/g) were about 2 logs lower for sliced tomatoes packaged with an XtendaPak™ absorbent food pad as compared with sliced tomatoes packaged with a regular absorbent food pad (Control).

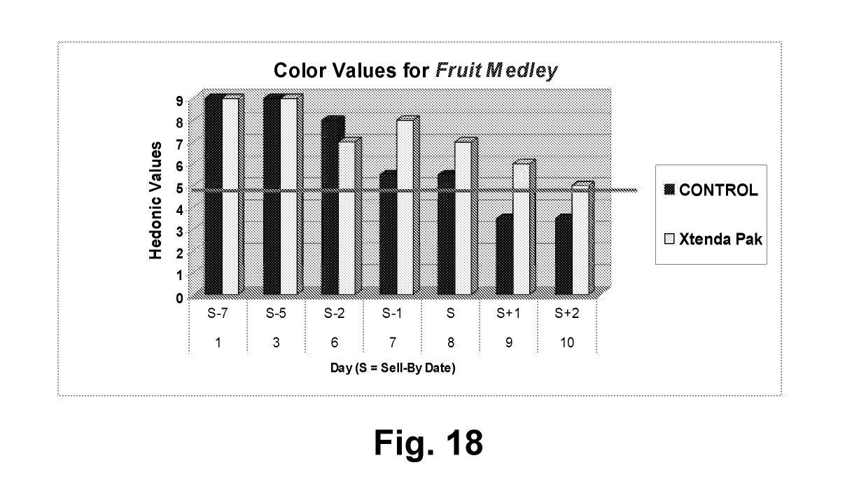

FIG. 18 is a bar graph showing color values for a “fruit medley” (variety of cut fruits) by hedonic values on a scale from 0 (worst) to 9 (best) over a 10-day test period between the “S−7” date (7 days before the sell-by date) and the “S+2” (2 days after the sell-by date) by comparing scores for an absorbent food pad having active agents that are a CO₂ generation system and an antimicrobial (XtendaPak™) with a regular (Control) absorbent food pad. These data show that the fruit medley in a food package with an XtendaPak™ absorbent food pad were rated better for hedonic values (color, appearance, smell, taste) than fruit packaged with a Control absorbent food pad. The difference between the XtendaPak™ package and the Control was most pronounced a day prior to the sell-by date, and the next two days thereafter.

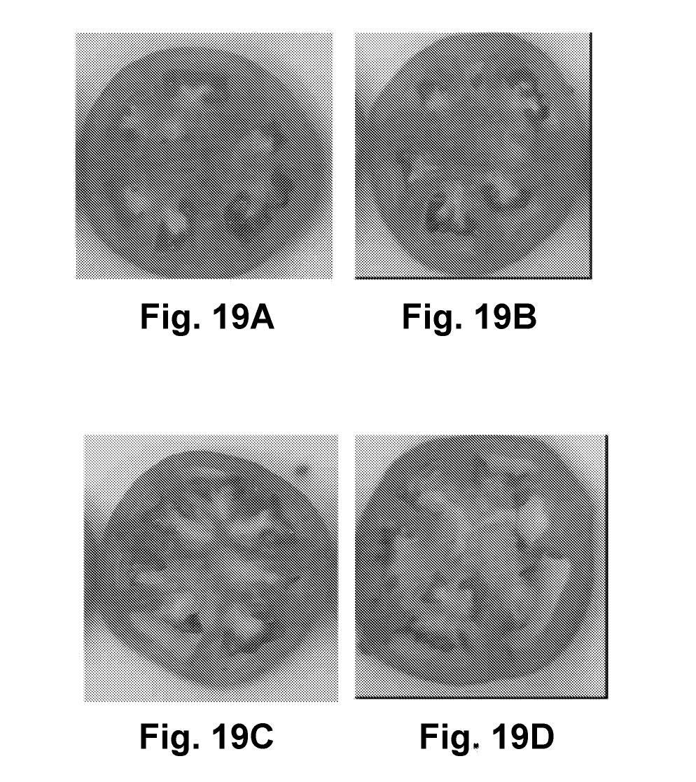

FIG. 19A through FIG. 19D are pictures showing the appearance of sliced tomatoes from a shelf-life study, where FIG. 19 A and FIG. 19B are sliced tomatoes at Day 10 and Day 12, respectively, for an absorbent food pad having active agents that are a CO₂ generation system and an antimicrobial (XtendaPak™) as compared against FIG. 19C and FIG. 19D, which show sliced tomatoes at Day 10 and Day 12, respectively, for a regular (Control) absorbent food pad. These pictures show that the tomato slices in a food package with an XtendaPak™ absorbent food pad appeared to be considerably fresher than tomato slices packaged with a Control absorbent food pad at Day 10, and especially at Day 12.

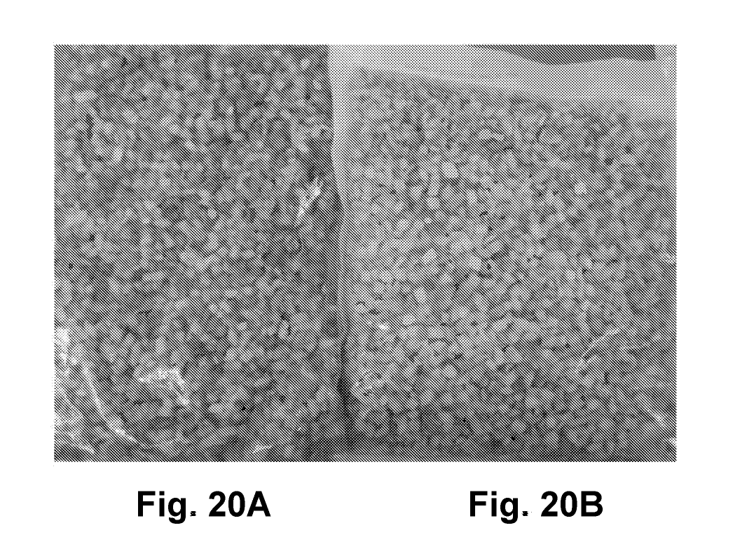

FIG. 20A and FIG. 20B show the results of a shelf-life study for cut celery placed in a food storage pouch at Day 14, where FIG. 20A is the cut celery when an XtendaPak™ absorbent food pad is used in the food storage pouch, as compared with FIG. 20B for cut celery stored with a Control absorbent food pad in the food storage pouch. These pictures show that cut celery in a food package with an XtendaPak™ absorbent food pad maintained a deeper green color and appeared fresher on Day 14 than cut celery packaged with a Control absorbent food pad.

As used herein, the word “about” means a range that is ±10% of the stated value, more preferably ±5% of the stated value, and most preferably ±1% of the stated value, including all subranges therebetween.

It should be understood that the foregoing description is only illustrative of the present disclosure. Various alternatives and modifications can be devised by those skilled in the art without departing from the disclosure. Accordingly, the present disclosure is intended to embrace all such alternatives, modifications, and variances that fall within the scope of the disclosure.

What is claimed is:

1. A food package system for cut or sliced produce that includes a food tray, a tray insert, and a closure, wherein the food tray has a bottom and side walls connected to the bottom that form a top opening, wherein the tray insert has an outer perimeter sized so the tray insert is positionable inside the food tray and forms a space therebetween, and wherein the closure encloses the top opening, the system comprising:
an active, absorbent food pad for cut or sliced produce positioned on the bottom of the food tray and directly below the tray insert, wherein the absorbent food pad has a pad architecture comprising:
a top layer;
a bottom layer;
an absorbent body between the top layer and the bottom layer; and
an active agent selected from the group consisting of: antimicrobial agent, atmosphere modifying system, and a combination thereof,
wherein the cut or sliced produce positioned on the tray insert exudes a liquid that is directed toward the outer perimeter of the tray insert, and which liquid is absorbed into the absorbent food pad.

2. The food package system according to claim 1, wherein the space provides a path for the exuded liquids from the cut or sliced produce to flow below the tray insert where the exuded liquids are absorbed by the absorbent food pad.

3. The food package system according to claim 1, wherein the outer edge of the tray insert forms a downward slope that increases the flow of exuded liquid to contact the absorbent food pad.

4. The food package system according to claim 1, wherein the cut or sliced produce is fresh produce.

5. The food package system according to claim 1, wherein the cut or sliced produce is selected from the group consisting of: tomato, onion, asparagus, celery, lettuce, melon, berry, pineapple, apple, grape, vegetable medley, fruit medley, and any combinations thereof.

6. The food package system according to claim 5, wherein the cut or sliced produce is sliced tomato or sliced onion.

7. The food package system according to claim 5, wherein the absorbent food pad absorbs liquids from the cut or sliced produce and keeps the absorbed liquids separated from the produce to extend shelf life, preserve appearance and other organoleptic features, and reduce spoilage of the cut or sliced produce in the food package system.

8. The food package system of claim 1, wherein the atmosphere modifying system is selected from a group consisting of: CO₂ generation system, O₂ scavenger system, ethylene scavenger system, ethylene antagonist, fungal inhibitor, antimicrobial, and any combinations thereof.

9. The food package according to claim 8, wherein the CO₂ generation system comprises an acid and a base.

10. The food package according to claim 9, wherein the acid is an organic acid selected from the group consisting of: citric acid, sorbic acid, acetylsalicylic acid, fumaric acid, ascorbic acid, estearic acid, lactic acid, and any combinations thereof.

11. The food package according to claim 9, wherein the acid is boric acid.

12. The food package system according to claim 1, wherein the absorbent body further comprises a tissue layer between the top layer and the bottom layer.

13. The food package system according to claim 1, wherein the absorbent body further comprises a superabsorbent material between the top layer and the bottom layer.

14. The food package system according to claim 13, wherein the superabsorbent material is biodegradable and/or compostable.

15. The food package system according to claim 1, wherein the absorbent body further comprises a laminate layer having one or more plies of a cellulosic material.

16. The food package system according to claim 1, wherein the absorption of the exuded liquids by the absorbent food pad, and separation of the absorbed liquids from the cut or sliced produce on the top side of the tray insert extends shelf life, improves appearance, and reduces spoilage of the cut or sliced produce in the food package system.

17. A food package system for cut or sliced produce that includes a food tray, a tray insert, and a closure, wherein the food tray has a bottom and side walls connected to the bottom that form a top opening, wherein the tray insert has an outer perimeter sized so the tray insert is positionable inside the food tray, and wherein the closure encloses the top opening, the system comprising:
an active, absorbent food pad for cut or sliced produce positioned on the bottom of the food tray and directly below the tray insert, wherein the absorbent food pad has a pad architecture comprising, from top-to-bottom:
a top layer that is a material selected from the group consisting of: polyethylene film, polypropylene film, nonwoven, coffee filter tissue, and any combinations thereof;
an absorbent body comprising:
a first tissue layer that is one or more tissues;
a laminate layer that is one or more plies of a cellulosic material;
a second tissue layer that is one or more tissues; and
an active agent in any of the first tissue layer, second tissue layer, and/or laminate layer; and
a bottom layer that is a material selected from the group consisting of: polyethylene film, polypropylene film, nonwoven, coffee filter tissue, and any combinations thereof.

18. The food package system according to claim 17, wherein the cut or sliced produce is selected from the group consisting of: tomato, onion, asparagus, celery, lettuce, melon, berry, pineapple, apple, grape, vegetable medley, fruit medley, and any combinations thereof.

19. The food package system of claim 17, wherein the atmosphere modifying system is selected from a group consisting of: CO₂ generation system, O₂ scavenger system, ethylene scavenger system, ethylene antagonist, fungal inhibitor, antimicrobial, and any combinations thereof.

20. A flexible storage pouch for cut or sliced produce, comprising:
a flexible pouch into which the cut or sliced produce is placed;
an active, absorbent food pad for cut or sliced produce positioned in the flexible pouch, wherein the absorbent food pad has a pad architecture comprising:
a top layer;
a bottom layer;
an absorbent medium between the top layer and the bottom layer; and
an active agent selected from the group consisting of: antimicrobial agent, atmosphere modifying system, and a combination thereof, wherein the active agent is present in the absorbent medium; and
wherein the cut or sliced produce and the absorbent food pad are enclosed and sealed in the flexible pouch, and
wherein the absorbent food pad absorbs liquid exuded by the cut or sliced produce in the flexible pouch, and thereby extends shelf life, improves appearance, and reduces spoilage of the cut or sliced produce in the flexible pouch.
